(19) United States
(12) Patent Application Publication
(10) Pub. No.: US 2009/0120515 A1
(43) Pub. Date: May 14, 2009

(54) FLOW RATE MEASUREMENT VALVE

(75) Inventors: Hideo Ohtani, Tokyo (JP); Motohiro Furuya, Tokyo (JP)

Correspondence Address: DARBY & DARBY P.C., P.O. BOX 770, Church Street Station, New York, NY, 10008-0770, US

(73) Assignee: Yamatake Corporation, Tokyo (JP)

(21) Appl. No.: 12/266,649

(22) Filed: Nov. 7, 2008

(30) Foreign Application Priority Data
Nov. 9, 2007 (JP) 2007-291397

(51) Int. Cl. F16K 37/00

(52) U.S. Cl. 137/553

(57) ABSTRACT

A flow rate measurement valve calculates the flow rate of the fluid flowing in a valve body from the differential pressure of the fluid pressure in a flow route upstream from a valve element arranged in the valve body and the fluid pressure in a flow route downstream from the valve element. The downstream fluid pressure is detected without the influence of dynamic pressure by detecting the pressure of fluid stopped in a fluid stagnation part formed in part of the flow route downstream from the valve element. The downstream fluid pressure is measured through a downstream fluid pressure conduction route that passes through an inner peripheral surface of the valve body facing the fluid stagnation part and an outer peripheral surface of the valve body where a downstream fluid pressure detection means is mounted.

### CROSS REFERENCE TO RELATED APPLICATION

This application claims the benefit under 35 U.S.C. §119 of Japanese Patent Application No. 2007-291397, filed on Nov. 9, 2007, which is hereby incorporated by reference herein in its entirety.

### FIELD OF THE INVENTION

The present invention relates to apparatus for adjusting the flow rate of a fluid running through a valve body, and more particularly to a flow rate measurement valve for calculating a flow rate from a pressure differential between the fluid pressure inside the flow route upstream from a valve element arranged inside the valve body and the fluid pressure inside the flow route on the downstream side, and from the amount of valve element openness.

### BACKGROUND OF THE INVENTION

In conventional building air conditioning systems, even if a valve element is set to a specified valve openness, there is the problem that, when the fluid pressure is high, the fluid flow rate running inside the valve body becomes higher than the target value. Specifically, wasteful energy consumption from running a greater amount of fluid than is necessary invites greater expense. In the past, attempts were made to resolve this problem by installing a flowmeter upstream or downstream from the valve body, detecting excess flow of the fluid by measuring the flow rate of the fluid, and responding by controlling the openness of the valve element so that the measured flow rate agrees with the target value.

Nonetheless, there is the problem with the method described above that both the flowmeter and the valve must be connected in line, taking up a large amount of plumbing space. Moreover, using both a flowmeter and a valve is a source of increased costs. An economical flow rate measurement valve providing both a flow rate measuring function and a valve function is desirable.

In a flow rate measurement valve, the flow rate Q of the fluid running inside the valve body can be calculated by measuring, and then substituting into a specified flow rate calculation formula, the valve element openness and the pressure differential ΔP between the fluid pressure in the flow route upstream from the valve element (upstream fluid pressure) and the fluid pressure in the flow route downstream from the valve element (downstream fluid pressure).

Technology related to this flow rate measurement valve has been disclosed, for example, in Japanese Unexamined Patent Application No. Sho 60-168974 and Japanese Examined Patent Application No. Hei 7-103945 (hereafter, Patent Literature 1 and 2, respectively). Patent Literature 1 discloses a flow rate control valve comprising inside the pipeline of the flow rate control valve a first pressure detection means for detecting fluid pressure in the upstream pipeline of valve body and a second pressure detection means for detecting fluid pressure in the downstream pipeline of valve body, wherein the flow rate of the fluid flowing inside the pipeline is calculated based on electric output signals of the first and second pressure detection means and the valve openness detection means.

Moreover, disclosed in Patent Literature 2 is a butterfly valve that measures the flow rate of a fluid passing through the valve body by incorporating the pressures from 4 pressure intake ports formed in a seat ring, averaging the pressures on the upstream and downstream sides of the seat ring using ring-shaped hollow parts, and extracting these to measure the differential pressure.

In the flow rate control valve of Patent Literature 1, the positions for detecting the upstream fluid pressure and the downstream fluid pressure are respectively arranged in locations separated from the valve body. In order to accurately detect the fluid pressure in the flow route, this separation is necessary so that the flow of the fluid will have effect on the measurement since, when the fluid passes nearby the valve body, the fluid pressure changes due to the disturbance produced corresponding to the degree of valve openness. Therefore, linear flow routes are respectively provided across sufficient lengths upstream and downstream of the valve body, and the respective pressure detection means are respectively installed such that the fluid pressure is measured from positions sufficiently separated from the valve body on both the upstream and downstream sides. Specifically, the downstream change of fluid pressure, which is caused by the disturbance produced corresponding to the degree of valve openness, is greater than that of the upstream side, and the position for detecting the fluid pressure on the downstream side is inevitably located at a clearly greater distance from the valve body than the position for detecting the fluid pressure on the upstream side.

For that reason, there are the problems that the surface dimensions of the valve in Patent Literature 1 are unavoidably large, and that there is no escaping a large-scale and heavy product. If the pressure detection means in Patent Literature 1 were arranged near the valve body on the downstream side without providing a sufficient length of linear flow route, the direction that the fluid flows inside the flow route would be changed by the degree of valve openness, the pressure inside the flow route would fluctuate corresponding to these changes, the fluid pressure on the downstream side could not be accurately detection, and as a result, the flow rate could not be measured with high precision.

Moreover, in Patent Literature 2, instead of providing a linear flow route, pressures extracted from pressure intake ports in 4 locations are led to the same hollow part, the pressures are averaged by mixing, and a stabilized pressure is detected. Nonetheless, the position of the pressure intake ports are not sufficiently separated from the valve body on the upstream and downstream sides, and therefore there is the problem that large fluctuations of fluid pressure caused by a disturbance produced corresponding to the degree of valve openness occur and the flow rate cannot be measured with high precision. The present invention intends to resolve the problems of the past described above, and to provide a flow rate measurement valve that is compact with small valve surface dimensions, and that can measure flow rate with high precision.

### SUMMARY OF THE INVENTION

A flow rate measurement valve according to a first embodiment of the present invention comprises: a valve element that is arranged inside the valve body and adjusts the flow rate of liquid passing through the interior of the valve body, a first pressure detection means for detecting the fluid pressure in the flow route upstream from the valve element, a second detection means for detecting the fluid pressure of the flow route downstream from the valve element, an amount of valve openness detection means for detecting the amount of openness of the valve element, and a flow rate calculation means for calculating the flow rate of fluid flowing inside the valve body based on the various detection signals of the first and second pressure detection means and the amount of valve openness detection means, further comprising: a fluid stagnation part that produces fluid stagnation near the valve element in the flow route downstream from the valve element in the valve body, and a downstream fluid pressure conduction route that passes through the inner peripheral surface of the valve body bordering the fluid stagnation part and through the outer peripheral surface of the valve body, wherein the second pressure detection means is mounted on the outer peripheral surface of the valve body, and is connected to the downstream fluid pressure conduction route.

In a flow rate measurement valve according to a second embodiment of the present invention, the valve is a globe valve that adjusts the flow rate of the fluid that passes through the interior of the valve body by changing the position of the valve element at the interior of the valve body associated with movement of the valve spindle that is mounted in the valve element, and the fluid stagnation part is an open space formed by the outer peripheral surface of the valve element and the inner peripheral surface of the valve body.

In a flow rate measurement valve according to a third embodiment of the present invention, the valve element is mounted with a valve spindle that is orthogonal to the axial line of the flow route of the valve body; the valve element is supported on the valve spindle so as to freely rotate inside the surface orthogonal to the valve spindle; and the valve element is formed into a roughly hemispherical body having a through hole through which the fluid passes, and the fluid stagnation part is the space formed by the outer peripheral surface of the valve element and the inner peripheral surface of the valve body.

### BRIEF DESCRIPTION OF THE DRAWINGS

The invention will become more readily apparent from the Detailed Description of the Invention, which proceeds with reference to the drawings, in which:

FIG. 1 is a cross-section diagram of flow rate measurement valve according to a first embodiment of the present invention;

FIG. 2 is a cross-section diagram of flow rate measurement valve according to a second embodiment of the present invention; and

FIG. 3 is a cross-section diagram of flow rate measurement valve according to a third embodiment of the present invention.

### DETAILED DESCRIPTION OF THE PREFERRED EMBODIMENTS

A listing of some of the reference numerals and letters that are used in the drawings, together with descriptions of the corresponding elements, is provided below:
1 Valve body
2 Valve element
3 Stagnant part of fluid
11 Upstream flow route
12 Downstream flow route
13 Valve chamber
14 Fluid stagnation part
18 Upstream fluid pressure conduction route
20 Downstream fluid pressure conduction route
21 Valve spindle
22 Actuator sampling part
23 Fluid regulating part
25 Amount of valve openness connection route detection means
26 Flow rate calculation means detection means
31 Fully closed position regulation part
32 Fully open position regulation part
33 Elastic member
34 O-ring
36 Seat ring
37 Retainer
38 Upstream fluid pressure sampling part
39 Upstream fluid pressure connection route
41 Upstream fluid pressure detection means
42 Downstream fluid pressure detection means
44 Upstream/downstream fluid pressure detection means
48 Ring-shaped groove
50 Display

According to a first embodiment of the present invention, a fluid stagnation part that produces fluid stagnation near the valve element in the flow route downstream from the valve element in the valve body, and a downstream fluid pressure conduction route that passes through an inner peripheral surface of the valve body bordering the fluid stagnation part and through an outer peripheral surface of the valve body are provided, and the second pressure detection means is mounted on the outer peripheral surface of the valve body and is connected to a downstream fluid pressure conduction route; therefore the surface dimensions can be made small, the downstream fluid pressure to be detected can be stably detected irrespective of the openness of the valve element, and a flow rate measurement valve that can measure flow rate with high precision can be realized because the downstream flow route can be shortened by taking the fluid pressure of the stagnant fluid inside the fluid stagnation part provided near the valve element in the downstream flow route as the downstream fluid pressure to be detected by a second pressure detection means.

Moreover, according to a second embodiment of the present invention, the valve may be a globe valve that adjusts the flow rate of the fluid that passes through the interior of the valve body by changing the position of the valve element at the interior of the valve body by moving a valve spindle that is mounted in the valve element, and the fluid stagnation part may be an open space formed by the outer peripheral surface of the valve element and the inner peripheral surface of the valve body. Therefore, the surface dimensions can be made small, the downstream fluid pressure to be detected can be stably detected irrespective of the openness of the valve element, and a globe type flow rate measurement valve that can measure flow rate with high precision can be realized.

Moreover, according to a third embodiment of the present invention, the valve element may be mounted with a valve spindle that is orthogonal to the axial line of the flow route of the valve main body. The valve element is supported on the valve spindle so as to freely rotate inside the surface orthogonal to the valve spindle; and is formed into a roughly hemispherical body having a through hole through which the fluid passes. The fluid stagnation part is the space formed by the outer peripheral surface of the valve element and the inner peripheral surface of the valve body. Therefore, the surface dimensions can be made small, the downstream fluid pressure to be detected can be stably detected irrespective of the openness of the valve element, and a rotary type flow rate measurement valve that can measure flow rate with high precision can be realized.

The present invention will be explained in detail below in conjunction with the drawings.

### Embodiment 1

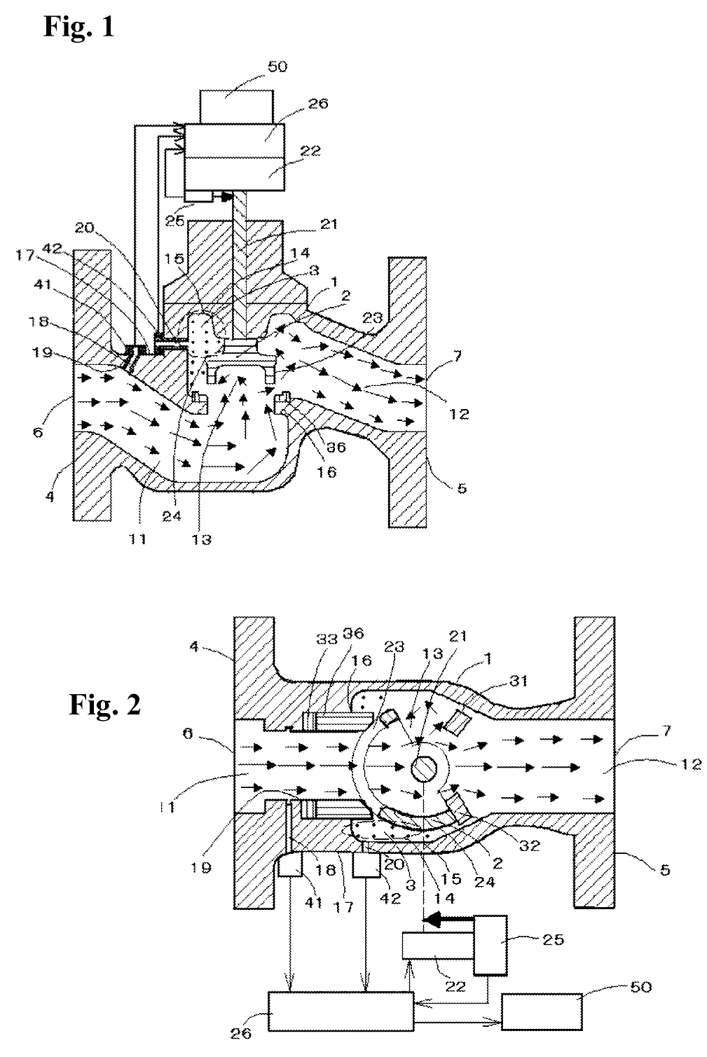

FIG. 1 is a cross-sectional diagram illustrating a first embodiment (embodiment 1) of a flow rate measurement valve according to the present invention. The type of valve used in this embodiment 1 is a globe valve. In FIG. 1, 1 is a valve body, 2 is a valve element, and 21 is a valve spindle; and the valve spindle 21 is mounted on the valve element 2. 22 is an actuator, and the valve openness of the valve element 2 is adjusted by moving the valve spindle 21 up and down to freely move the valve element 2 in the axial linear direction of the valve spindle 21. Because of the similarity to general glove valves, these mechanisms will not be described in detail.

25 is an amount of valve openness detection means that uses the valve spindle 21 position data to detect the amount of valve openness of the valve element 2, and outputs to a flow rate calculation means 26, to be described later, electric output signals indicating the amount of valve openness detected.

4 is an upstream flange part of the valve body 1, which mates with the flange part of an exterior pipe on the upstream side (not shown), and is fastened thereto using fastening members (not shown). 5 is a downstream flange part which mates with an exterior pipe on the downstream side (not shown), and is fastened thereto using fastening members (not shown).

11 is an upstream flow route, and is arranged upstream from the valve element 2. 6 is an inlet port at the upstream end of the upstream flow route 11. 12 is a downstream flow route, and is arranged downstream from the valve element 2. 7 is an outlet port at the downstream end of the downstream flow route 12. Moreover, a valve chamber 13 is provided between the upstream flow route 11 and the downstream flow route 12, and the valve element 2 is housed inside the valve chamber 13. Further, the arrows appearing in the various locations inside the upstream flow route 11 and the downstream flow route 12 schematically represent the direction of fluid flow and flow velocity at the various locations.

36 is a seat ring, and is mounted on a valve seat 16 of the valve body 1 that touches a border part between the aforementioned valve chamber 13 and the upstream flow route 11. 23 is a flow rate adjustment part of the valve element 2, and when fully closed, contacts the seat ring 36 to block the flow of fluid from the upstream side to the downstream side, and when not fully closed, separates from the seat ring 36, and fluid passes from the upstream side to the downstream side through that space.

14 is a fluid stagnation part, which is a part of the downstream flow route 12, and is a space formed by an outer peripheral surface 24 of the valve element 2 and an inner peripheral surface 15 of the valve body 1 near the valve element 2. 3 is the stagnant part of the fluid, and is fluid that has flowed into the downstream side and is stopped in the fluid stagnation part 14. The dots represented in the stagnant part 3 of the fluid schematically indicated that the fluid does not flow in the stagnant part 3.

41 is an upstream fluid pressure detection means (first pressure detection means) mounted on an outer peripheral surface 17 of the valve body 1. 18 is an upstream fluid pressure conduction route that passes through an upstream inner peripheral surface 19 of the valve body 1, which is at a sufficient distance upstream from the position where the seat ring 36 contacts the valve element 2, and through the outer peripheral surface 17 of valve body 1 where the upstream fluid pressure detection means 41 is mounted; and the upstream fluid pressure is detected by the upstream pressure detection means 41 after being relayed through the upstream fluid pressure conduction route 18.

42 is a downstream fluid pressure detection means (second pressure detection means) mounted on the outer peripheral surface 17 of the valve body 1. 20 is a downstream fluid pressure conduction route that passes through an the inner peripheral surface 15 of the valve body 1, which faces the fluid stagnation part 14, and through the outer peripheral surface 17 where the downstream fluid pressure detection means 42 is mounted; and the fluid pressure of the stagnant part 3 fluid stopped inside the fluid stagnation part 14 is detected as the downstream fluid pressure by the downstream pressure detection means 42 after being relayed through the downstream fluid pressure conduction route 20.

The upstream fluid pressure detected by the upstream fluid pressure detection means 41 and the downstream fluid pressure detected by the downstream fluid pressure detection means 42 are respectively output as electric output signals to the flow rate calculation means 26. The flow rate is calculated by the flow rate calculation means 26 following a specified flow rate calculation formula from the signals indicating the amount of valve openness of the valve element 2 input from the amount of valve openness detection means 25, the upstream fluid pressure input from the upstream fluid pressure detection means 41, and the downstream fluid pressure input from the downstream fluid pressure detection means 42. The results of calculating the flow rate by the flow rate calculation means 26 are output as a feedback value to the actuator 22, are used by the actuator 22 to control the openness of the valve element 2, and are also output to a display means 50 for display of the measured flow rate on the display means 50.

The flow rate measurement valve of the present invention differs from conventional measurement apparatus, and is configured such that the stagnant part 3 fluid pressure of the fluid stopped inside the fluid stagnation part 14 is detected by the downstream fluid pressure detection means 42 as the downstream fluid pressure. The reason that the detection of the stagnant part 3 fluid pressure of the fluid inside the fluid stagnation part 14 as the downstream fluid pressure can measure the flow rate with high precision will be explained below.

The fluid stagnation part included in the first embodiment of the present invention is not provided in the downstream flow route of the conventional flow rate measurement valve represented by Patent Literature 1. Therefore, the fluid in the downstream flow route is not present in a stagnant part, and is flowing in every location, but the direction of the flow of the fluid in the downstream flow route based on the openness of the valve element is different depending on the location. Thus, non-uniform disturbances of the flow of fluid are produced, and there are places of high fluid pressure and places of low fluid pressure associated with this. This phenomenon is notable near the valve element where the cross-sectional area of the flow route varies greatly, and the error of this fluid pressure converges and is averaged as the distance from the valve element increases. Moreover, this phenomenon is even more notable when the openness of the valve element changes. In other words, because the flowing fluid is affected by the dynamic pressure, only the static pressure, which is the pressure that the fluid itself has, can be detected, and therefore the fluid pressure cannot be detected with high precision.

Nonetheless, the fluid stagnation part is provided near the valve element such that fluid that is not flowing inside the downstream flow route, specifically, stagnant fluid, is present. When conducting experiments to measure the fluid pressure of the stagnant fluid of the fluid stagnation part while varying the openness of the valve element, the inventors confirmed that the pressure measured at the stagnation part was correlated with the pressure measured at a position sufficiently distant downstream from the valve element. It may be assumed that this is because the stagnant fluid is not flowing and only the static pressure can be detected without the influence of the dynamic pressure. Consequently, the downstream fluid pressure can be detected with high precision, and therefore high-precision flow rate measurements can be taken as a result. At the same time, by providing this fluid stagnation part near the valve element in the downstream flow route, the length of the downstream flow route can be shortened, the surface dimensions of the valve body can be made smaller, and a compact, light-weight flow rate measurement valve can be achieved. Further, there is the advantage that the shape of the downstream flow route 12 of the valve body 1 can be designed based on a conventional globe valve with only slight modifications.

Continuing, another embodiment according to the present invention will be explained.

### Embodiment 2

FIG. 2 is a cross-sectional diagram illustrating another embodiment (embodiment 2) of a flow rate measurement valve according to the present invention. In this embodiment, the valve type is a rotary valve. In FIG. 2 the same codes are assigned to parts constituting the same functions as those in embodiment 1, and further detailed explanation of these will be omitted. The flow rate measurement valve related to this embodiment 2 has the following points of difference from the flow rate measurement valve of embodiment 1: The axial line of the upstream flow route 11 and the downstream flow route 12 inside the valve body 1 are arranged in the same straight line; and the valve element 2 is formed into a hollow roughly hemispherical body having a fluid route through hole 23 that is the flow rate adjustment part of the fluid that passes through, this valve element 2 is supported on the valve spindle 21 positioned orthogonally to the axial line of the flow route, and is supported so as to freely rotate within the surface (cross-section in FIG. 2) orthogonal to the valve spindle 21.

First, the parts newly indicated in FIG. 2 that are not indicated in FIG. 1 will be explained. 31 is a part of the valve body 1, and when the valve element 2 is rotated to the fully closed position, this part is a fully closed position regulating part that protrudes from the valve body 1 to make contact with the valve element 2. 32 is a part of the valve body 1, and when the valve element 2 is rotated to the fully open position, this part is a fully open position regulating part that protrudes from the valve body 1 to make contact with the valve element 2. Further, in FIG. 2, the valve element 2 is indicated in the fully open state, and the valve element 2 is making contact with the fully open position regulating part 32.

33 is an elastic member supported between the seat ring 36 and the inner peripheral surface 19 on the upstream side of the valve body 1, and by being compressed when mounted, manifests a pressurizing force that forces the seat ring 36 onto the valve element 2 thereby functions to maintain the seal characteristics between the valve element 2 and the seat ring 36.

These points of difference have a different structure, but in embodiment 2, part of the downstream flow route 12 is the same as that of embodiment 1. Hollow fluid stagnation part 14 formed by the outer peripheral surface 24 of the valve element 2 and the inner peripheral surface 15 of the valve body 1 near the valve element 2, and the fluid 3 that is stopped in this fluid stagnation part 14 is stopped irrespective of the degree of openness of the valve element 2. Moreover, in the same way as in embodiment 1, 41 is a upstream fluid pressure detection means (first pressure detection means) mounted on the outer peripheral surface 17 of the valve body 1; and 18 is an upstream fluid pressure conduction route that passes through an upstream inner peripheral surface 19 of the valve body 1, which is at a sufficient distance upstream from the position where the seat ring 36 contacts the valve element 2, and the outer peripheral surface 17 where the upstream fluid pressure detection means 41 is mounted; and the upstream fluid pressure is detected by the upstream pressure detection means 41 through the upstream fluid pressure conduction route 18.

42 is a downstream fluid pressure detection means (second pressure detection means) mounted on the outer peripheral surface 17 of the valve body 1. 20 is a downstream fluid pressure conduction route that passes through the inner peripheral surface 15 of the valve body 1, which faces the fluid stagnation part 14, and the outer peripheral surface 17 where the downstream fluid pressure detection means 42 is mounted; and the fluid pressure of the stagnant part 3 fluid stopped inside the fluid stagnation part 14 is detected by the downstream pressure detection means 42 through the downstream fluid pressure conduction route 20.

The upstream fluid pressure detected by the upstream fluid pressure detection means 41 and the downstream fluid pressure detected by the downstream fluid pressure detection means 42 are respectively output as electric output signals to the flow rate calculation means 26. The flow rate is calculated by the flow rate calculation means 26 following a specified flow rate calculation formula from the signals indicating the amount of valve openness of the valve element 2 input from the amount of valve openness detection means 25, the signals indicating the upstream fluid pressure input from the upstream fluid pressure detection means 41, and the signals indicating the downstream fluid pressure input from the downstream fluid pressure detection means 42. The results of calculating the flow rate by the flow rate calculation means 26 are output as a feedback value to the actuator 22, are used by the actuator 22 to control the openness of the valve element 2, and are also output to a display means 50 for display of the measured flow rate on the display means 50.

Because a rotary valve is used as the valve type in the flow rate measurement valve of embodiment 2, a more compact flow rate measurement valve can be expected than that of embodiment 1, which is configured using a general globe valve. Further, as previously described, because embodiment 2 is configured to detect the fluid pressure of the fluid stagnation part 3 as the downstream fluid pressure, the downstream fluid pressure can be more precisely detected, and high precision flow rate measurement can be conducted.

Moreover, by forming the fluid stagnation part 14 by the outer peripheral surface 24 of the valve element 2 and the inner peripheral surface 15 of the valve body 1 near the valve element 2, the length of the downstream flow route 12 is shorter than that of the conventional rotary type flow rate measurement valve; therefore the surface dimensions can be made small, and a compact, light-weight flow rate measurement valve can be achieved. Further, there is the advantage that the shape of the downstream flow route 12 of the valve body 1 can be designed based on a conventional globe valve with only slight modifications.

Continuing, another embodiment according to the present invention will be explained.

### Embodiment 3

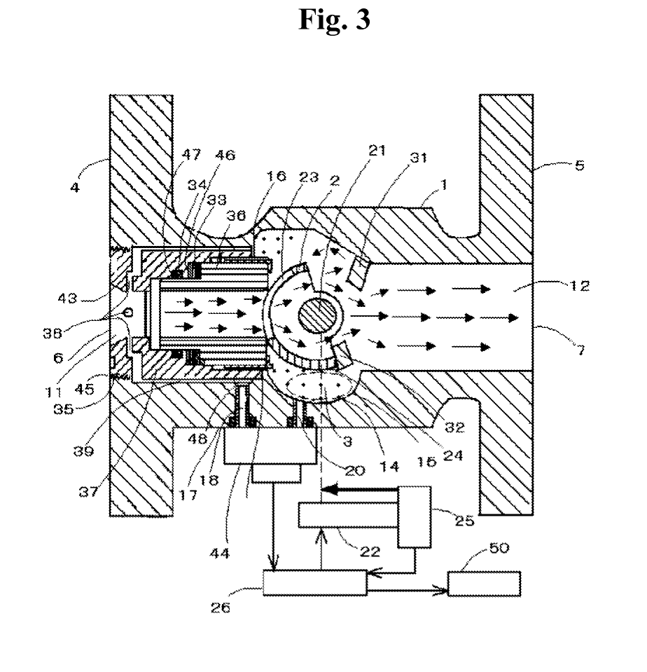

FIG. 3 is a cross-sectional diagram indicating another embodiment (embodiment 3) of a flow rate measurement valve related to the present invention. In this embodiment, the valve type is a rotary valve like in embodiment 2. In FIG. 3 the same codes are assigned to parts constituting the same functions as those previous described in embodiment 2.

The flow rate measurement valve related to this embodiment 3 has the following points of difference from the flow rate measurement valve of embodiment 2: Instead of the upstream fluid pressure detection means 41 and the downstream fluid pressure detection means 42, a upstream/downstream fluid pressure detection means 44, which simultaneously detects the upstream fluid pressure and the downstream fluid pressure, is mounted on the outer peripheral surface 17 of the valve body 1; and provided in the upstream flow route 11 is a retainer 37, which retains the seat ring 36 as the upstream fluid pressure is led to the upstream/downstream fluid pressure detection means 44. The structures of the valve element 2 and of the downstream flow route 12 are basically the same. Consequently, discussion will center on the points of difference from embodiment 2, and the details of the points in common with embodiment 2 will be omitted.

Arranged on the upstream side of the valve element 2 inside the valve body 1 are the seat ring 36, which makes tight contact with the outer peripheral 24 of the valve element 2, the retainer 37, which retains this seat ring 36 so as to move freely in the axial linear direction of the upstream flow route 11, the elastic member 33, which pressurizes the seat ring 36 onto the valve element 2, and an O-ring 34 for sealing between the seat ring 36 and the retainer 37. The seal structure of the seat ring part is thereby configured. The aforementioned seat ring 36 is formed into a cylinder with both ends open; the upstream end part is thinner with a smaller diameter part, while the downstream end part is thicker with a larger diameter part; and this seat ring is pressed against the valve element 2 by the elastic part 33.

The aforementioned retainer 37 is formed into a cylinder with both ends open, and houses the aforementioned seat ring 36 so as to move freely in the axial linear direction of the upstream flow route 11. Male threads are formed on the outer peripheral surface 35 of the upstream end part, and the retainer screws into the female threads formed on the inner peripheral surface 45 of the upstream opening part of the valve body 1. In addition, an upstream opening part 43 of the retainer 37 forms a tapered hole with the small diameter facing from the open end surface to the downstream side, and the inner diameter of the smallest diameter part is equivalent to the hole diameter of the aforementioned seat ring 36.

Moreover, a ring-shaped housing part 46 for housing the aforementioned elastic member 33 is formed between an inner peripheral surface of the retainer 37 and an outer peripheral surface of the seat ring 36. This housing part 46 is constituted by a stage difference part formed in the outer peripheral surface of the seat ring 36, and a stage difference part formed in the inner peripheral surface of the retainer 37. Further, a ring-shaped groove 47 with which the aforementioned O-ring 34 mates is formed in the inner peripheral surface of the retainer 37.

Four upstream fluid pressure sampling parts 38, which constitute through holes that pass between the inner peripheral surface and the outer peripheral surface of the retainer 37, are formed at equal intervals in the peripheral direction near the smallest diameter part of the taper hole of the upstream opening part 43 of the retainer 37. Further, four upstream fluid pressure connection routes 39 are formed at equal intervals in the peripheral direction on the downstream outer peripheral surface from the part where the upstream fluid pressure sampling parts 38 are formed. These upstream fluid pressure connection routes 39 compose grooves formed in the axial linear direction of the retainer, and the upstream ends connect to the aforementioned upstream fluid pressure sampling parts 38. Further, a ring-shaped groove 48, which connects through with the downstream sides of the aforementioned 4 upstream fluid pressure connection routes 39, is formed at the downstream end of the outer peripheral surface of the retainer 37. In addition, to be able to stably detect the upstream fluid pressure irrespective of the openness of the valve element 2, the dimensions in the axial direction of the retainer 37 are stipulated so that the opening parts at the inner peripheral surface of the retainer 37 of the upstream fluid pressure sampling parts 38 have sufficient distance from the position where the seat ring 36 and the outer peripheral surface of the valve element 2 make contact.

Meanwhile, an upstream fluid pressure conduction route 18, which connects the aforementioned upstream fluid pressure connection routes 39 to the upstream/downstream fluid pressure detection means 44 through the aforementioned ring-shaped groove 48, is formed in the valve body 1. Because the upstream fluid pressure conduction route 18 is formed between upstream fluid pressure connection routes 39 of the valve body 1 near the valve element 2 and the outer peripheral surface 17 of the valve body 1 near the valve element 2 where the upstream/downstream fluid pressure detection means 44 is mounted, the fluid pressure of the aforementioned upstream flow route 11 passes through the upstream fluid pressure sampling parts 38 to the upstream fluid pressure connection routes 39 to the upstream fluid pressure conduction route 18, and this pressure is led to the upstream/downstream fluid pressure detection means 44.

The upstream/downstream fluid pressure detection means 44 forms into a single body the upstream fluid pressure detection means 41 and the downstream fluid pressure detection means 42 as used in embodiments 1 and 2. While the upstream fluid pressure is detected as described above, the fluid pressure of the stagnant part 3 of the fluid stopped in the fluid stagnation part 14, which is a space formed by the outer peripheral surface 24 of the valve element 2 in the downstream flow route 12 of the valve body 1 and the inner peripheral surface 15 of the valve body 1 near the valve element 2, passes through the downstream fluid pressure conduction route 20, which passes through the inner peripheral surface 15 of the valve body 1 facing the fluid stagnation part 14 and the outer peripheral surface 17 of the valve body 1 on which the upstream/downstream fluid pressure detection means 44 is mounted, and this pressure is detected as the downstream fluid pressure.

The upstream fluid pressure and the downstream fluid pressure detected by the upstream/downstream fluid pressure detection means 44 is output as electrical output signals respectively to the flow rate calculation means 26. The flow rate is calculated by the flow rate calculation means 26 following a specified flow rate calculation formula from the signals indicating the amount of valve openness of the valve element 2 input from the amount of valve openness detection means 25, the upstream fluid pressure, and the downstream fluid pressure. The results of calculating the flow rate by the flow rate calculation means 26 are output as a feedback values to the actuator 22, are used by the actuator 22 to control the openness of the valve element 2, and are also output to a display means 50 for display of the measured flow rate on the display means 50. Further, the upstream/downstream fluid pressure detection means 44 may be configured such that, instead of outputting the upstream fluid pressure and the downstream fluid pressure respectively to the flow rate calculation means 26, the differential pressure between the upstream fluid pressure and the downstream fluid pressure may be derived, and differential pressure signals may be output as the electric output signals to the flow rate calculation means 26.

Adding to the advantages of the second embodiment of the present invention, the flow rate measurement valve of the third embodiment of the present invention can detect the upstream fluid pressure and the downstream fluid pressure using the upstream/downstream fluid pressure detection means 44, and therefore the pressure detection means can be made into single unit and the number of parts can be reduced. Moreover, because the upstream fluid pressure conduction route 18 and the downstream fluid pressure conduction route 20 are close together, the upstream/downstream fluid pressure detection means 44 can be used in a compact valve. In addition, because the upstream/downstream fluid pressure detection means 44 and the flow rate calculation means 26 are close together, the signal line connecting the upstream/downstream fluid pressure detection means 44 and the flow rate calculation means 26 can be short, having the overall advantage of making a more compact and inexpensive flow rate measurement valve.

Thus, those skilled in the art will readily recognize numerous adaptations and modifications, which can be made to the present invention which fall within the scope of the present invention as defined in the claims.

For example, to detect the fluid pressure of the downstream fluid route, rather than the valve body of the present invention, a different type of valve from those of the previously described embodiments, for example, a butterfly valve, may be used as long as the fluid pressure of a stagnant part of the fluid, specifically, a part where the fluid does not flow, is measured, and the fluid pressure is led to the downstream fluid pressure detection means from a position that fulfills this condition.

It is intended that the scope of the present invention include all foreseeable equivalents to the elements and structures as described with reference to FIGS. 1-3. Accordingly, the invention is to be limited only by the scope of the claims and their equivalents.

1: A flow rate measurement valve comprising:
a valve element that is arranged inside the valve body and adjusts the flow rate of fluid passing through the interior of said valve body;
a first pressure detector for detecting the fluid pressure in the flow route upstream from said valve element;
a second detector for detecting the fluid pressure of the flow route downstream from said valve element;
a valve openness detector for detecting the amount of openness of said valve element;
a flow rate calculation means for calculating the flow rate of fluid flowing inside said valve body based on the various detection signals of said first and second pressure detectors and said valve openness detector;
a fluid stagnation part that produces fluid stagnation near said valve element in the flow route downstream from said valve element in the valve body, and
a downstream fluid pressure conduction route that passes through an inner peripheral surface of said valve body bordering said fluid stagnation part and through an outer peripheral surface of the valve body,
wherein said second pressure detector is mounted on the outer peripheral surface of said valve body and is connected to said downstream fluid pressure conduction route.

2. The flow rate measurement valve according to claim 1, wherein:
said valve comprises a globe valve that adjusts the flow rate of the fluid that passes through the interior of said valve body by changing the position of said valve element at the interior of said valve body by moving a valve spindle that is mounted in said valve element; and
said fluid stagnation part is an open space formed by portions of an outer peripheral surface of said valve element and the inner peripheral surface of said valve body.

3. The flow rate measurement valve according to claim 1, wherein:
said valve element is mounted with a valve spindle that is orthogonal to an axial direction of the flow routes of said valve body;
said valve element is supported on said valve spindle so as to freely rotate inside the surface orthogonal to said valve spindle;
said valve element is formed into a roughly hemispherical body having a through hole through which the fluid passes, and
said fluid stagnation part is a space formed by portions of an outer peripheral surface of said valve element and the inner peripheral surface of said valve body.
